(19) United States
(12) Patent Application Publication
(10) Pub. No.: US 2008/0066799 A1
(43) Pub. Date: Mar. 20, 2008

(54) Optical Concentrator for Solar Cell Electrical Power Generation

(75) Inventor: Roy Clark, Thousand Oaks, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: PRATT & WHITNEY ROCKETDYNE, INC., Canoga Park, CA (US)

(21) Appl. No.: 11/939,024

(22) Filed: Nov. 13, 2007

Related U.S. Application Data
(63) Continuation of application No. 10/699,480, filed on Oct. 30, 2003.

(51) Int. Cl. H02N 6/00

(52) U.S. Cl. 136/246

(57) ABSTRACT

A representative method involving an optical concentrator for a power generation solar cell includes: providing a Fresnel lens of the optical concentrator, the Fresnel lens having an exit aperture half width corresponding to the width of the solar cell; and providing a secondary non-imaging concentrating element of the optical concentrator, the secondary non-imaging concentrating element exhibiting a hyperbola asymptote angle larger than a divergence angle of the Fresnel lens.

This application is a continuation of U.S. patent application Ser. No. 10/699,480, filed Oct. 30, 2003, which is incorporated by reference herein.

### FIELD OF THE INVENTION

This invention relates generally to the field of solar cells and, more particularly, to a combination of a Fresnel lens with a non-imaging optical concentrator to accommodate solar tracking system misalignment for reduced solar cell area and increased tolerance for tracking system angular error.

### BACKGROUND OF THE INVENTION

The major cost driver in electrical power generation using solar cells is the cost of the cells themselves. In order to reduce this cost, a solar concentration system can be employed that places a higher solar light intensity onto a smaller solar array. Prior art includes reflective solar dishes and concentrators based on Fresnel lenses of various types. However, the use of such concentrators requires a solar tracking system that keeps the collection optics aligned with the sun as it moves across the sky. The cost of such a tracking system is significant and may negate the cost advantage of using a concentrator to increase illumination intensity and reduce the number of solar cells required to generate electricity. One of the major cost elements in a solar tracking system is the accuracy with which the concentrated sunlight can be placed on a small group of solar cells. Prior art, using for example the linear curved Fresnel lens design revealed in U.S. Pat. No. 4,069,812, requires that the array of solar cells be larger than the size of the concentrated solar illumination in order to compensate for inaccuracies in the tracking mechanism. Typically, the size of the solar array is increased by a factor of 2 to 4 just to compensate for the inaccuracies in the tracking system.

The basic Fresnel lens was introduced by Augustine Fresnel in 1822 and used initially for lighthouses. Instead of fabricating a very large, thick lens 2, the Fresnel lens 4 is made from thin sections with varying sizes and slopes. This is illustrated in FIG. 1. If the sections are linear in shape, a cylindrical lens is produced that brings the light to a line focus. If the sections are circular, a spherical lens is produced that brings the light to a point focus. A major improvement in the art of making large linear Fresnel lenses was revealed by O'Neill (U.S. Pat. No. 4,069,812). Instead of making the lens flat, the lens is curved and the additional optical magnification power gained from the curved surface leads to improved optical throughput. The curved Fresnel lens 6 is illustrated in FIG. 2 with the resulting convergence angle 8 for the edges rays projected by the lens. Subsequent patents reveal the art of improved solar cell mounting (U.S. Pat. No. 5,498,297) improved radiation protection (U.S. Pat. No. 5,505,789), improved color mixing (U.S. Pat. No. 6,031,179) and means of deployment of such lenses for space power applications (U.S. Pat. Nos. 6,075,200 and 6,111,190). However, none of this prior art reveals the use of a secondary concentrator to reduce the misalignment sensitivity.

Another means of improving the efficiency of a Fresnel lens is revealed in U.S. Pat. No. 4,337,759. In this case a second layer of a transparent (plastic) material of a different refractive index is laminated to the first. Total internal reflection (TIR) at the specially contoured interface between the two materials leads to a significant improvement in optical throughput. In this invention however, the device was used as an illuminator to expand and collimate the light source instead of as a solar concentrator. Although a tracking means was included, this was aimed at a general target, not at the sun. Subsequent patents (U.S. Pat. No. 5,404,869 and U.S. Pat. No. 5,577,492) reveal improved devices using curved facets at the internally reflecting interface. U.S. Pat. No. 5,577,493 reveals the use of an additional conventional lens to improve illumination uniformity. U.S. Pat. Nos. 5,613,769 and 5,676,453 reveal an essentially cylindrical lens design to be used for example in tubular (fluorescent) lighting fixtures and U.S. Pat. No. 5,806,955 reveals an arrangement for using a TIR lens for optical display backlighting.

The art of designing non-imaging optical elements is well known and as shown for example in Welford and Winston [Welford, W. T. & R. Winston, High Collection Nonimaging Optics, Academic Press, San Diego, Calif., 1989]. Although there are many different designs of optical concentrator, they can be classified into four principal types. The first is the compound parabolic concentrator. The second is the hyperbolic or ‘trumpet’ concentrator. The third type consists of concentrators designed using the edge ray principle as described for example by Gordon and Ries [Gordon, J. M. & H. Ries, Applied Optics 32(13) 2243-22s 1 (1997), Tailored edge ray concentrators as ideal second stages for Fresnel reflectors], Ong et al [Ong, P. T.; J. M. Gordon & A. Rabi, Applied Optics 34(34) 7877-7887 (1993), Tailoring lighting reflectors to prescribed illuminance distributions: compact partial involute designs; Ong, P. T.; J. M. Gordon & A. Rabi, Applied Optics 35(22) 4361-4371 (1996), Tailored edge ray designs for illumination with tubular sources; Ong, P. T.; J. M. Gordon, A. Rabi & W. Cai, Optical Engineering 34(6) 1726-1737 (1995), Tailored edge ray designs for uniform illumination of distant targets], Rabi [Rabi, A., Applied Optics 33(7) 1248-1259 (1994), Edge ray method for analysis of radiation transfer among specular reflectors] and Rabi and Gordon [Rabi, A. & J. M. Gordon, Applied Optics 33(25) 6012-6021 (1994), Reflector design for illumination with extended sources: the basic solutions]. The fourth type are all dielectric concentrators in which total internal reflection is used to concentrate the light. Such devices were discussed by Friedman and Gordon [Friedman, R. P. & J. M. Gordon, Applied Optics 35(34) 6684-6691 (1996), Optical designs for ultrahigh flux IR and solar energy collection: monolithic dielectric tailored edge ray concentrators]. These design types are illustrated in FIGS. 3a, 3b, 3c, 3d, 3e, 3f and 3g.

### SUMMARY OF THE INVENTION

An exemplary embodiment of an optical concentrator for a power generation solar cell comprises: a Fresnel lens mounted over the solar cell and being operative to focus sunlight over the solar cell when the concentrator is aligned with the sun: and a secondary non-imaging concentrating element mounted intermediate the Fresnel lens and the solar cell and operative to re-direct sunlight onto the solar cell when the concentrator is misaligned; the secondary non-imaging concentrating element exhibiting an exit angle selected to illuminate the solar cell without incurring excessive reflective losses due to Fresnel reflections from the internal semi-conductor surfaces of the cell.

An exemplary embodiment of a method involving an optical concentrator for a power generation solar cell comprises: providing a Fresnel lens of the optical concentrator, the Fresnel lens having an exit aperture half width corresponding to the width of the solar cell; providing a secondary non-imaging concentrating element of the optical concentrator, the secondary non-imaging concentrating element exhibiting an exit angle selected to illuminate the solar cell without incurring excessive reflective losses due to Fresnel reflections from the internal semi-conductor surfaces of the solar cell; and positioning the Fresnel lens, the secondary non-imaging concentrating element and the solar cell relative to each other such that the distance between the exit aperture and the Fresnel lens enables the solar cell to be illuminated by direct light that is not reflected by the secondary non-imaging concentrating element when the optical concentrator is optimally pointed at the sun.

An exemplary embodiment of a method involving an optical concentrator for a power generation solar cell comprises: providing a Fresnel lens of the optical concentrator, the Fresnel lens having an exit aperture half width corresponding to the width of the solar cell; and providing a secondary non-imaging concentrating element of the optical concentrator, the secondary non-imaging concentrating element exhibiting a hyperbola asymptote angle larger than a divergence angle of the Fresnel lens.

### BRIEF DESCRIPTION OF THE DRAWINGS

These and other features and advantages of the present invention will be better understood by reference to the following detailed description when considered in connection with the accompanying drawings wherein:

FIG. 1 is a depiction of a basic Fresnel lens as compared to the configuration of a normal curved lens;

FIG. 2 is a depiction of a curved Fresnel lens;

FIG. 3a is an exemplary parabolic concentrator applicable to the present invention;

FIG. 3b is an exemplary hyperbolic concentrator applicable to the present invention;

FIG. 3c is an example of a far edge diverging concentrator applicable to the present invention;

FIG. 3d is an example of a near edge diverging concentrator applicable to the present invention;

FIG. 3e is an example of a far edge converging concentrator applicable to the present invention;

FIG. 3f is an example of a near edge converging concentrator applicable to the present invention;

FIG. 3g is an example of a dielectric concentrator applicable to the present invention;

FIGS. 3h and 3i are generalized linearizations of the curved surfaces of the concentrators in FIGS. 3a through 3f;

FIG. 4 is an exemplary embodiment of the present invention employing a V-trough concentrator;

FIG. 5 is a graphical depiction of an exemplary means for determining the contour of the V-trough concentrator of FIG. 4; and,

FIG. 6 is a graphical depiction of the V-trough concentrator and the divergence angle of the Fresnel lens;

FIG. 7 is a plot of the calculated hyperbola and best line fit for a V-trough for the exemplary embodiment of the invention; and

FIG. 8 is a schematic representation of a solar tracking system employing the present invention.

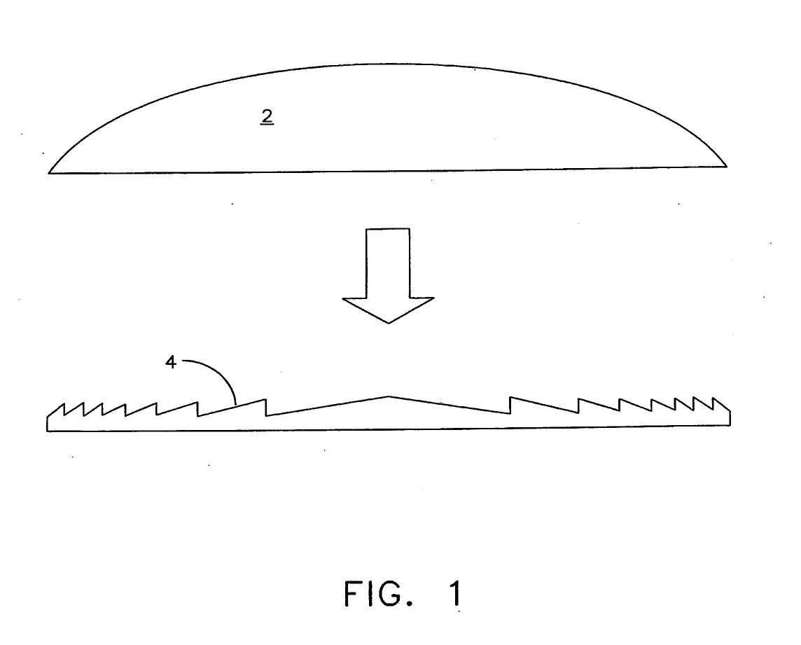

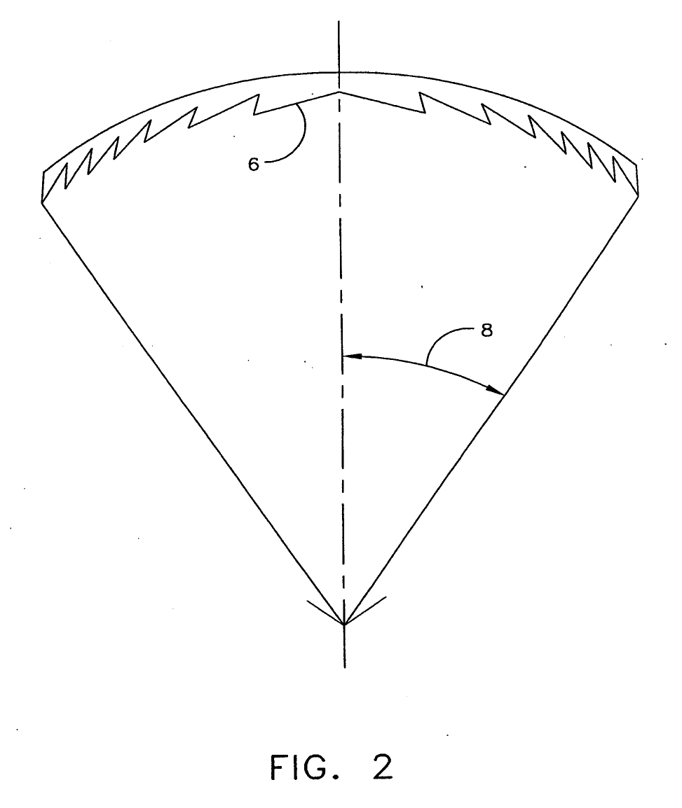

### DETAILED DESCRIPTION OF THE INVENTION

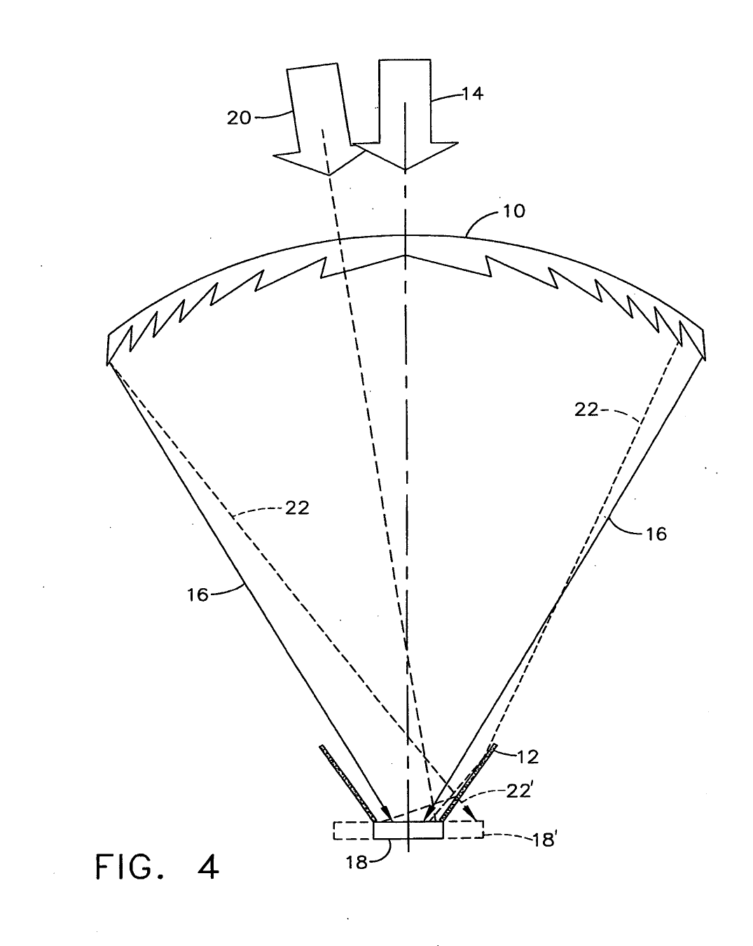

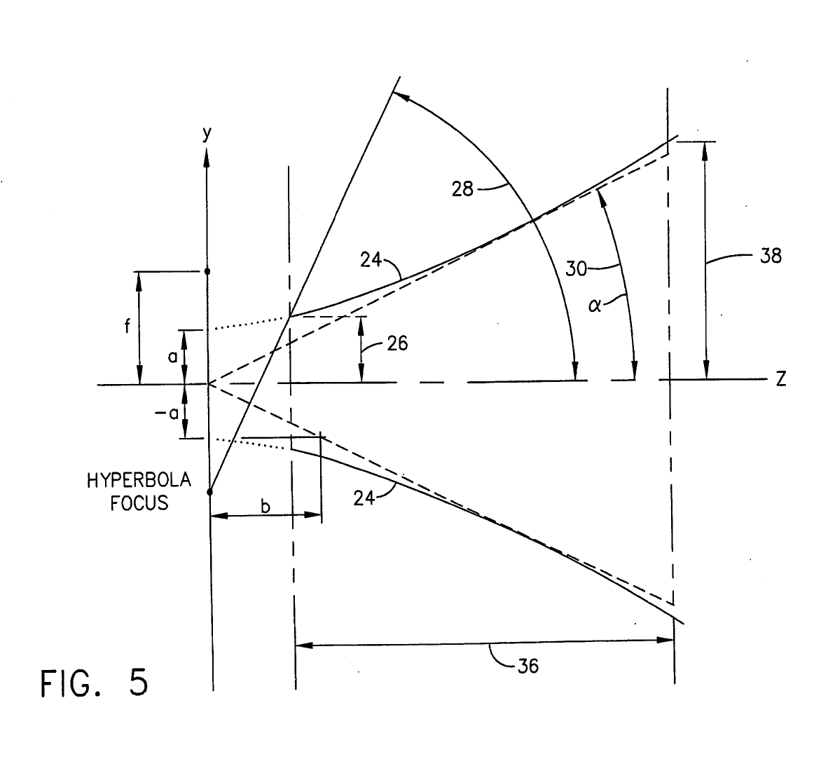

Referring to the drawings, an embodiment of the present invention is revealed in FIG. 4. A linear Fresnel concentrator, as disclosed for example in U.S. Pat. No. 4,069,812, having a lens 10 is structurally supported at a predefined distance from a secondary concentrator 12. When the tracking system is fully aligned, sunlight from the direction indicated by the arrow 14 is concentrated by the curved Fresnel lens. As demonstrated by the edge rays of the concentrated light shown as path 16, all light impinging on the lens is directly incident on the solar cell 18 within the periphery of the active surface area for the cell. While a single solar cell is referred to herein, the present invention is also employed with multiple cells arranged to accommodate an extended linear Fresnel lens. When the tracking system is misaligned, sunlight now enters the lens from the direction indicated by the arrow 20. The edge rays of the concentrated light now follow the directions shown by path 22. The light which would normally miss the solar cell active surface area (represented by lines 22′) without oversizing the cell (shown in phantom as 18′ as in conventional systems employing solely a Fresnel lens as the concentrator) is now reflected by the secondary concentrator and redirected onto the active area of the solar cell. For the embodiment shown, the concentrator is a simple V-trough whose contour is derived from a straight line fit to an optimized section of a hyperbolic concentrator. This approach is illustrated in FIG. 5. Such a design approach is described, for example, in Welford and Winston (previously referenced).

As an example for a 1 meter Fresnel lens having a 1 meter focal point, the hyperbolic surface 24 is designed based on a desired exit aperture half width 26 which is determined by the width of the solar cell, which may also include a cover plate or other optically transmissive means for protecting the cell surface from contamination. This optically transmissive element may also incorporate additional means of changing the divergence angle of the exit beam from the secondary concentrator. A typical value for this half width is 1 cm.

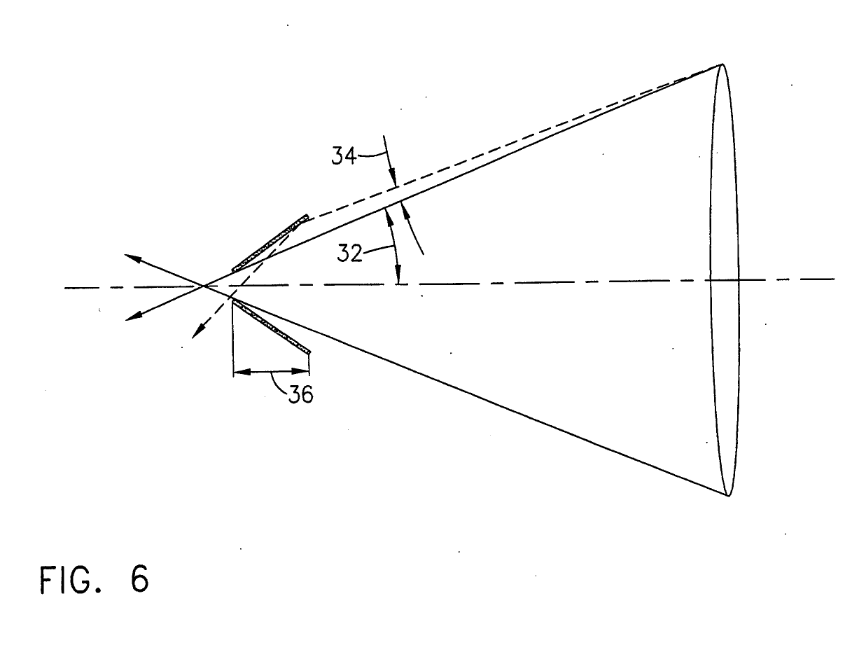

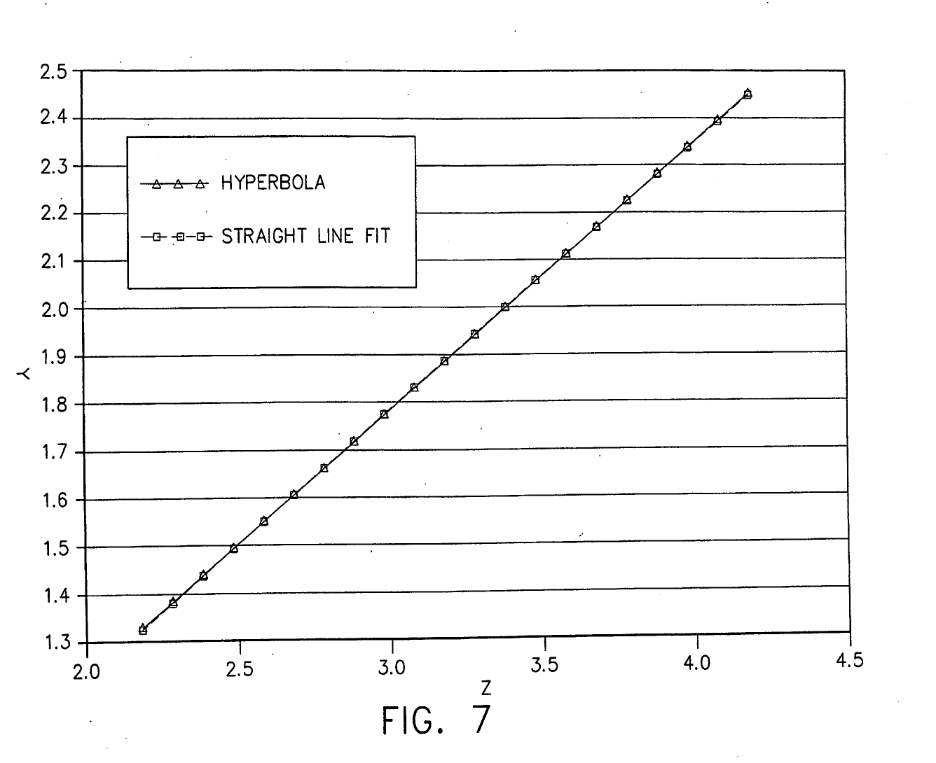

An exit angle, θ, 28 is selected to illuminate the solar cell without incurring excessive reflective losses due to Fresnel reflections from the internal semiconductor surfaces of the cell. A typical value is 40 degrees. The distance between the exit aperture and the primary Fresnel lens is selected so that the cell is illuminated by direct light that is not reflected by the secondary concentrator when the optical tracking system is optimally pointed at the sun. The asymptote angle, α, 30 of the hyperbola is selected to be slightly larger than the divergence angle 32 of the primary Fresnel lens to capture the edge rays from the lens at the maximum angular error for the optical tracking system, as best seen in FIG. 6. For the exemplary 1 meter Fresnel lens with a 1 meter focal point the divergence angle is approximately 27 degrees and a typical value for the asymptote angle is 30 degrees thereby providing a misalignment angle 34 of approximately 3 degrees. Using the defined values of the exit angle, the asymptote angle and the exit aperture half width, the hyperbola parameters “a”, “b” and “f” can be calculated. Since the hyperbola parameter “a” must be less than the value of the exit aperture, a simple iterative procedure can be used. Z is calculated from tan(θ)=(y+f)/z with y fixed to the desired exit aperture size. “y” is calculated from this value of “z” using the hyperbola equation y²/a²−z²/b²=1. “f” and “b” are expressed in terms of “a” using tan(a)=a/b and f²=a²+b². The variable parameter “a” is then adjusted until the desired value of y is reached.

The length 36 of the secondary concentrator that defines the entrance aperture half width 38, in conjunction with the selected asymptote angle discussed above, is determined from the maximum tracking error to be corrected. The best straight line fit to the hyperbola length determined based on the selected iterative parameters discussed above determines the practical secondary concentrator shape.

The calculations for the exemplary hyperbola and resulting V-trough discussed above are shown in Table 1.

TABLE 1

| Alpha | 30 | | | | |
|---|---|---|---|---|---|
| Theta | 40 | | | | |
| Exit | | | | | |
| Aperture | | | | | |
| Half | | | | | |
| Width | 1 | | | | |
| Tan(Alpha) | 0.57735 | | | | |
| Tan(Theta) | 0.8391 | | | | |
| a | 0.41635 | | | | |
| b | 0.721139 | | | | |
| f | 0.8327 | | f = sqrt(a\hat{ }2 + b\hat{ }2) | | |
| z | 2.184127 | | z = (0.5 + f)/tan(theta) | | |
| y | 1.327962 | | y = sqrt(a\hat{ }2 * (1 + z\hat{ }2/b\hat{ }2)) | | |
| z Increment | 0.1 | | | | |
| | | Hyperbola | St Line Fit | | |
| z | 2.184127 | 1.327962 | 1.324414 | slope | 0.562181 |
| | 2.284127 | 1.382905 | 1.380632 | Intercept | 0.09654 |
| | 2.384127 | 1.438066 | 1.43685 | | |
| | 2.484127 | 1.493422 | 1.493068 | | |
| | 2.584127 | 1.548952 | 1.549286 | | |
| | 2.684127 | 1.604637 | 1.605504 | | |
| | 2.784127 | 1.660462 | 1.661722 | | |
| | 2.884127 | 1.716414 | 1.71794 | | |
| | 2.984127 | 1.77248 | 1.774158 | | |
| | 3.084127 | 1.82865 | 1.830376 | | |
| | 3.184127 | 1.884914 | 1.886594 | | |
| | 3.284127 | 1.941265 | 1.942812 | | |
| | 3.384127 | 1.997695 | 1.99903 | | |
| | 3.484127 | 2.054197 | 2.055248 | | |
| | 3.584127 | 2.110767 | 2.111466 | | |
| | 3.684127 | 2.167397 | 2.167684 | | |
| | 3.784127 | 2.224085 | 2.223903 | | |
| | 3.884127 | 2.280825 | 2.280121 | | |
| | 3.984127 | 2.337613 | 2.336339 | | |
| | 4.084127 | 2.394447 | 2.392557 | | |
| | 4.184127 | 2.451323 | 2.448775 | | |

The resulting straight line fit for the V-trough is shown in FIG. 7 wherein the ideal hyperbola shape is shown as line 40 and the straight line fit is shown as line 42.

This design approach may also be refined using more advanced ray-tracing techniques found in commercial illumination software packages such as Light Tools, Optical Research Associates, Pasadena, Calif. and ASAP, Breault Research Organization, Tucson, Ariz.

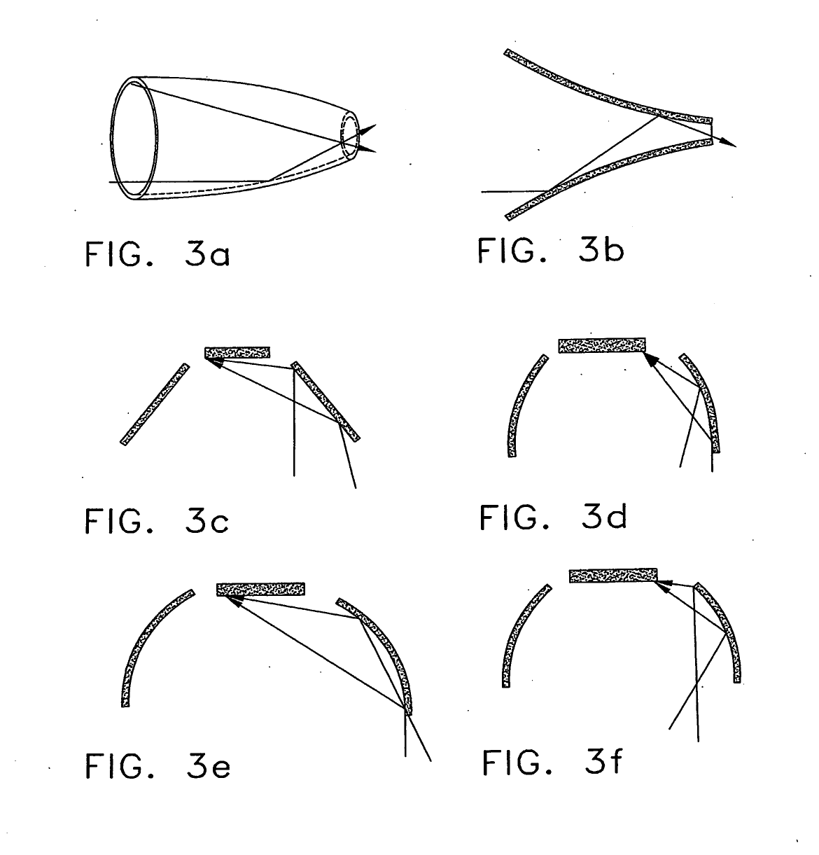

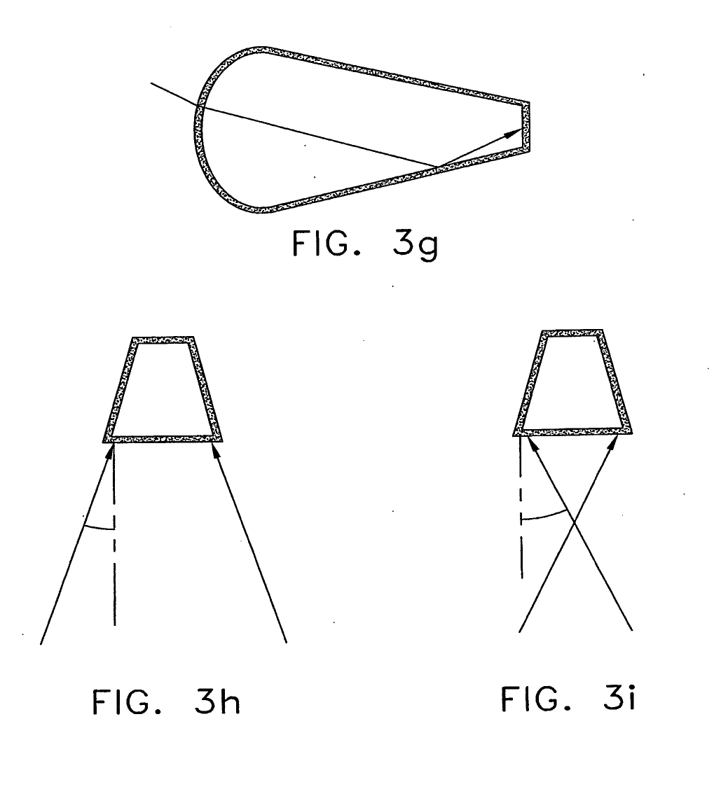

The present invention is not limited to a V-trough concentrator. Many other types of concentrator such as the parabolic or true hyperbolic concentrator, hollow concentrators derived from edge ray design principles and monolithic dielectric concentrators are employed in alternative embodiments of this invention. Although the design method is different and in some cases more complex than the embodiment shown in the drawings, the net result is the same: a secondary concentrator with a defined acceptance angle and a surface contour that may be simplified, if desired, to a best fit straight line through the optimum curve. The choice of straight line or curve is a practical one based on system cost and efficiency considerations. In all cases, the acceptance angle of the concentrator can be arranged to accommodate alignment errors in the solar tracking system. FIGS. 3h and 3i demonstrate the generalized best fit straight line embodiment conceptually derived for an arbitrary one of the concentrators of FIGS. 3a-3f.

Further, in each case, an entrance aperture for the secondary concentrator defined by the length of the secondary concentrator and a primary reflection angle associated with the geometry, corresponding to the asymptote angle for the hyperbola shown in the embodiment described in detail herein, is defined to accommodate a predetermined misalignment angle for the tracking system with exit angle and exit aperture defined to accommodate the particular cell size and configuration. Furthermore, although the for the embodiment of the invention disclosed, a linear Fresnel lens is employed, a circular Fresnel lens is employed in alternative embodiments. In this embodiment, a cone is substituted for the V-trough using the same design principle and having a section view across a diameter identical to FIG. 4. Many other more complex surfaces may be derived using the design principles known to those skilled in the art of making optical concentrators. Instead of a circular Fresnel lens, two orthogonal cylindrical Fresnel lenses may be used. The Fresnel lenses may be of a conventional design, curved design, or contain TIR elements.

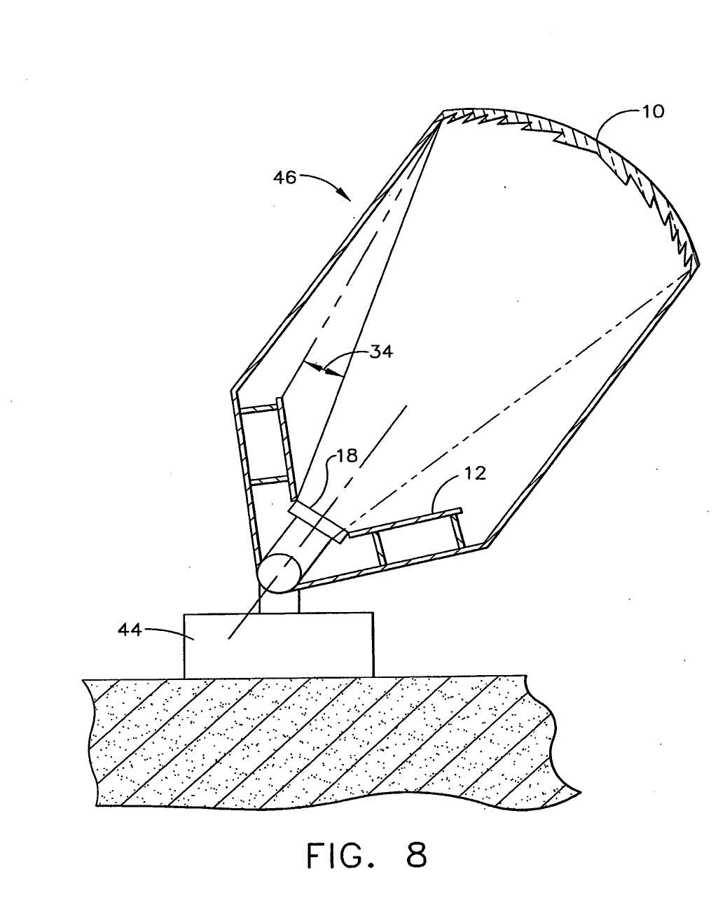

Implemented at the system level as shown schematically (with the lens at much reduced scale) in FIG. 8, the tracking system 44 supports the solar cell 18 and the concentrator system 46 employing the Fresnel lens 10 and secondary concentrator 12. The predetermined misalignment angle for the tracking system is accommodated by the secondary concentrator to allow practical constraints on the alignment accuracy of the system resulting in lower cost and complexity.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. An optical concentrator for a power generation solar cell, the solar cell having internal semi-conductor surfaces, said optical concentrator comprising:
a Fresnel lens mounted over the solar cell and being operative to focus sunlight over the solar cell when the concentrator is aligned with the sun: and
a secondary non-imaging concentrating element mounted intermediate the Fresnel lens and the solar cell and operative to re-direct sunlight onto the solar cell when the concentrator is misaligned;
the secondary non-imaging concentrating element exhibiting an exit angle selected to illuminate the solar cell without incurring excessive reflective losses due to Fresnel reflections from the internal semi-conductor surfaces of the cell.

2. The optical concentrator of claim 1, wherein the solar cell receives edge rays from the Fresnel lens at a periphery of an active surface of the solar cell when the concentrator is aligned with the sun without the edge rays being reflected by the secondary non-imaging concentrating element.

3. The optical concentrator of claim 2, wherein all light directed by the Fresnel lens is incident on the active surface of the solar cell.

4. The optical concentrator of claim 2, wherein the secondary non-imaging concentrating element has an entrance aperture sized to receive edge rays within the convergence angle of the Fresnel lens, when the concentrator is misaligned by a predetermined misalignment angle, and an exit aperture sized to a dimension equal to the periphery of the solar cell active surface.

5. A method involving an optical concentrator for a power generation solar cell, the solar cell having internal semi-conductor surfaces, said method comprising:
providing a Fresnel lens of the optical concentrator, the Fresnel lens having an exit aperture half width corresponding to the width of the solar cell;
providing a secondary non-imaging concentrating element of the optical concentrator, the secondary non-imaging concentrating element exhibiting an exit angle selected to illuminate the solar cell without incurring excessive reflective losses due to Fresnel reflections from the internal semi-conductor surfaces of the solar cell; and
positioning the Fresnel lens, the secondary non-imaging concentrating element and the solar cell relative to each other such that the distance between the exit aperture and the Fresnel lens enables the solar cell to be illuminated by direct light that is not reflected by the secondary non-imaging concentrating element when the optical concentrator is optimally pointed at the sun.

6. The method of claim 5, further comprising selecting a hyperbola asymptote angle of the secondary non-imaging concentrating element larger than a divergence angle of the Fresnel lens.

7. The method of claim 6, further comprising calculating hyperbola parameters using values of the exit angle, the hyperbola asymptote angle and the exit aperture half width.

8. The method of claim 7, wherein the exit aperture half width is selected based, at least in part, on the width of the solar cell.

9. The method of claim 7, wherein calculating the hyperbola parameters comprises iteratively calculating the hyperbola parameters.

10. The method of claim 7, wherein calculating the hyperbola parameters comprises calculating “a”, “b” and “f” by:
determining the exit angle, the hyperbola asymptote angle and the exit aperture half width; and
tan(hyperbola asymptote angle)=a/b;
calculating “z” from tan(exit angle)=(y+f)/z, with “y” being fixed to the desired exit aperture half width; and
calculating “y” the value of “z” using the hyperbola equation y²/a²−z²/b²=1 and f²=a²+b².

11. The method of claim 10, wherein in calculating “a”, “b” and “f”, “a” is adjusted until a desired value of “y” is achieved.

12. The method of claim 10, further comprising forming the secondary non-imaging concentrating element using the values of “a”, “b” and “f” calculated.

13. The method of claim 7, wherein the secondary non-imaging concentrating element shape is based, at least in part, on a best straight-line fit to a hyperbola length determined.

14. The method of claim 5, further comprising selecting a length of the secondary non-imaging concentrating element based, at least in part, on a maximum tracking error to be corrected associated with an optical tracking system for positioning the Fresnel lens and the secondary non-imaging concentrating element.

15. A method involving an optical concentrator for a power generation solar cell, said method comprising:
providing a Fresnel lens of the optical concentrator, the Fresnel lens having an exit aperture half width corresponding to the width of the solar cell; and
providing a secondary non-imaging concentrating element of the optical concentrator, the secondary non-imaging concentrating element exhibiting a hyperbola asymptote angle larger than a divergence angle of the Fresnel lens.

16. The method of claim 15, wherein the secondary non-imaging concentrating element exhibits an exit angle operative to illuminate the solar cell without incurring excessive reflective losses due to Fresnel reflections from internal semi-conductor surfaces of the solar cell.

17. The method of claim 15, further comprising receiving edge rays from the Fresnel lens at a periphery of an active surface of the solar cell when the concentrator is aligned with the sun without the edge rays being reflected by the secondary non-imaging concentrating element.

18. The method of claim 15, wherein the secondary non-imaging concentrating element exhibits a length selected, at least in part, on a maximum tracking error to be corrected associated with an optical tracking system for positioning the Fresnel lens and the secondary non-imaging concentrating element.

19. The method of claim 15, wherein the secondary non-imaging concentrating element exhibits an exit aperture sized to a dimension equal to the periphery of the solar cell active surface.

20. The method of claim 15, further comprising:
using the optical concentrator to concentrate light onto the solar cell; and
generating electrical power with the solar cell.
